(19) United States
(12) Patent Application Publication
(10) Pub. No.: US 2011/0113529 A1
(43) Pub. Date: May 19, 2011

(54) CLIP FOR HEADWEAR

(76) Inventor: Giuseppe Dino MILIOTO, LAVAL (CA)

(21) Appl. No.: 12/904,531

(22) Filed: Oct. 14, 2010

Related U.S. Application Data
(60) Provisional application No. 61/272,637, filed on Oct. 14, 2009.

(51) Int. Cl. A42B 1/24; F16B 2/20

(52) U.S. Cl. 2/209.13; 24/3.12

(57) ABSTRACT

A clip for holding articles and being mountable to headwear includes a first body member and second body member pivotally mounted thereto. The first and second body members include respective first and second mating elements. The second body member is movable between a closed position, wherein the first and second elements are mutually engaged and an open position wherein the first and second elements are disengaged thereby providing for the second body member to pivot away from the first body member. In the closed position, the first and second body members provide for holding articles therebetween. A bottom portion extends from the first body member is insertable within a slot formed in the headwear.

### CROSS-REFERENCE TO RELATED APPLICATIONS

The present application claims priority on U.S. Provisional Patent Application Ser. No. 61/272,637 filed on Oct. 14, 2009 and incorporated herein in its entirety.

### TECHNICAL FIELD

The present disclosure n relates headwear such as a helmet, a hard hat and the like. More specifically, but not exclusively, the present disclosure relates to a clip that is positioned on such headwear for carrying articles such as safety glasses, goggles, rulers, pens and the like.

### BACKGROUND

Many construction worksite accidents are caused by misplacing goggles and articles that workers need to carry. For example, workers tend to remove goggles often when not on a worksite and many fail to put them back on because they have been misplaced, this increases dangers to eyesight accidents.

Workers tend to place their safety glasses on their helmets by positioning the arms through an opening or slit along the side of the helmet; such practices are also dangerous since the glasses can be easily damaged and they are also difficult to properly remove thus increasing the risk of workers actually putting on their safety glasses due to the inconvenience of easily placing them within easy reach. Losing or dropping safety glasses is also very common when workers are standing on an elevated surface such as a ladder or machinery.

### OBJECTS

An object of the present disclosure is to provide a clip for holding articles being mountable to headwear.

An object of the present disclosure is to provide a clip for holding articles that is removably locked on a hard had with a slot.

An object of the present disclosure is to provide an assembly comprising headwear with a clip for holding articles.

An object of the present disclosure is to provide a headwear with a clip for holding articles.

### SUMMARY

In accordance with an aspect of the present invention, there is provided a clip for holding articles and being mountable to headwear, the clip comprising:
a first body member having a portion thereof including a first mating element; and
a second body member pivotally mounted to the first body member at one end thereof and having a second end thereof including a second mating element, the second body member being movable between a closed position wherein the first and second elements are mutually engaged and an open position wherein the first and second elements are disengaged thereby providing for the second body member to pivot away from the first body member,
wherein when in the closed position the first and second body members provide for holding articles therebetween.

In an embodiment, the first mating element comprises a notch and the second mating element comprises a corresponding tongue.

In an embodiment, the first and second body members comprise inner sides comprising respective deformable elements for holding the articles therebetween. In an embodiment, the respective deformable elements comprise respective slits.

In an embodiment, the clip defines top and bottom ends, the mating elements being positioned at the top end of the clip thereof.

In an embodiment, the clip further comprises a bottom extension comprising a depressible and resilient protuberating portion. In an embodiment, the protuberating portion is upwardly sloped defining a shoulder. In an embodiment, the bottom extension comprises an additional shoulder positioned above the shoulder defined by the depressible member. In an embodiment, the bottom extension comprises a main portion flanked by pair of separate flaps.

In an embodiment, the first mating element comprises a tab extending therefrom providing for manual disengagement of the first mating element from the second mating element when in the closed position.

In accordance with another aspect of the present disclosure, there is provided clip for holding articles and being mountable to headwear comprising a shell, a rim and a slot structure defining a slot that leads to the underside of the rim, the clip comprising:
a first body member having a portion thereof including a first mating element;
a second body member pivotally mounted to the first body member at one end thereof and having a second end thereof including a second mating element, the second body member being movable between a closed position wherein the first and second elements are mutually engaged thereby providing for the first and second body members to hold articles therebetween and an open position wherein the first and second elements are disengaged thereby providing for the second body member to pivot away from the first body member; and
a bottom extension for being fitted thought the slot thereby mounting the clip to the headwear, the bottom extension extending from the first body portion and comprising a protuberating deformable and resilient portion forming a shoulder and being depressible,
wherein when fitting the bottom extension into the slot, the protuberating portion is so depressible as to provide for the bottom extension to be positioned through the slot structure.

In an embodiment, the bottom portion is fitted through the slot, the shoulder of the protuberating portion engages the rim underside thereby acting as a stopper against disengaging the clip from the headwear. In an embodiment, bottom portion further comprises an additional shoulder, wherein when the bottom portion is fitted through the slot, the additional shoulder engages the slot structure. In an embodiment, the protuberating portion comprises an upwardly sloped depressible member.

In accordance with another aspect of the disclosure A headwear and clip assembly comprising:
a headwear comprising a shell, a rim and a slot structure defining a slot that leads to the underside of the rim; and
a clip mountable to the headwear for holding articles, the clip comprising: a first body member having a portion thereof including a first mating element; a second body member pivotally mounted to the first body member at one end thereof and having a second end thereof including a second mating element, the second body member being movable between a closed position wherein the first and second elements are mutually engaged thereby providing for the first and second body members to hold articles therebetween and an open position wherein the first and second elements are disengaged thereby providing for the second body member to pivot away from the first body member; and a bottom extension for being fitted thought the slot thereby mounting the clip to the headwear, the bottom extension extending from the first body portion and comprising a protuberating deformable and resilient portion forming a shoulder and being depressible,
wherein when fitting the bottom extension into the slot, the protuberating portion is so depressible as to provide for the bottom extension to be positioned through the slot structure.

In an embodiment, clips for holding articles being mountable to headwear as well as headwear including such clips are provided. The clip comprises a first and body members. The first body has a portion thereof including a first mating element. The second body is pivotally mounted to the first body member at one end thereof and includes a second end thereof having a second mating element. The second body member is movable between a closed position, wherein the first and second elements are mutually engaged and an open position, wherein the first and second elements are disengaged thereby providing for the second body member to pivot away from the first body member. When in the closed position the first and second body members provide for holding articles therebetween.

In an embodiment, a clip for holding articles and being mountable to headwear includes a first body member and second body member pivotally mounted thereto. The first and second body members include respective first and second mating elements. The second body member is movable between a closed position, wherein the first and second elements are mutually engaged and an open position wherein the first and second elements are disengaged thereby providing for the second body member to pivot away from the first body member. In the closed position, the first and second body members provide for holding articles therebetween. A bottom portion extends from the first body member is insertable within a slot formed in the headwear.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a front elevational view of the clip in accordance with a non-restrictive embodiment of the present disclosure;

FIG. 2 is a perspective view of the clip of FIG. 1 in an open position;

FIG. 3 is a lateral side view of the clip of FIG. 1 in a closed position;

FIG. 4 is perspective view of a clip in accordance with another non-restrictive embodiment of the present disclosure being in an open position and including safety glasses mounted thereto;

FIG. 5 is lateral side view of the clip in a in accordance with another non-restrictive embodiment of the present disclosure in a closed position;

FIG. 6 is perspective view of the clip of FIG. 4 being in an open position and including safety glasses mounted thereto;

FIG. 7 is a perspective view of the clip of FIG. 4 being either mounted or removed from a hard hat, with the clip holding safety glasses;

FIG. 8 is a perspective view of the clip of FIG. 4 mounted to the hard hat, with the clip holding safety glasses; and

FIG. 9 is a perspective view of a headwear and clip assembly in accordance with another non-restrictive embodiment of the present disclosure, with the clip holding safety glasses.

### DETAILED DESCRIPTION OF ILLUSTRATIVE EMBODIMENTS

Generally stated and in accordance with an embodiment of the present disclosure there is provided a clip for holding articles that is mountable to headwear as well as headwear including this clip. The clip includes pivotally connected first and second body members mutually movable between open and closed positions. When the first and second members are in the closed position they provide for holding articles therebetween and the articles are released therefrom when in the open position. The first and second members include respective deformable elements opposite each other for engaging these articles. These deformable elements can also be resilient.

With reference to the appended drawings, an illustrative embodiment of the present invention will be described herein so as exemplify the invention and by no means limit the scope thereof.

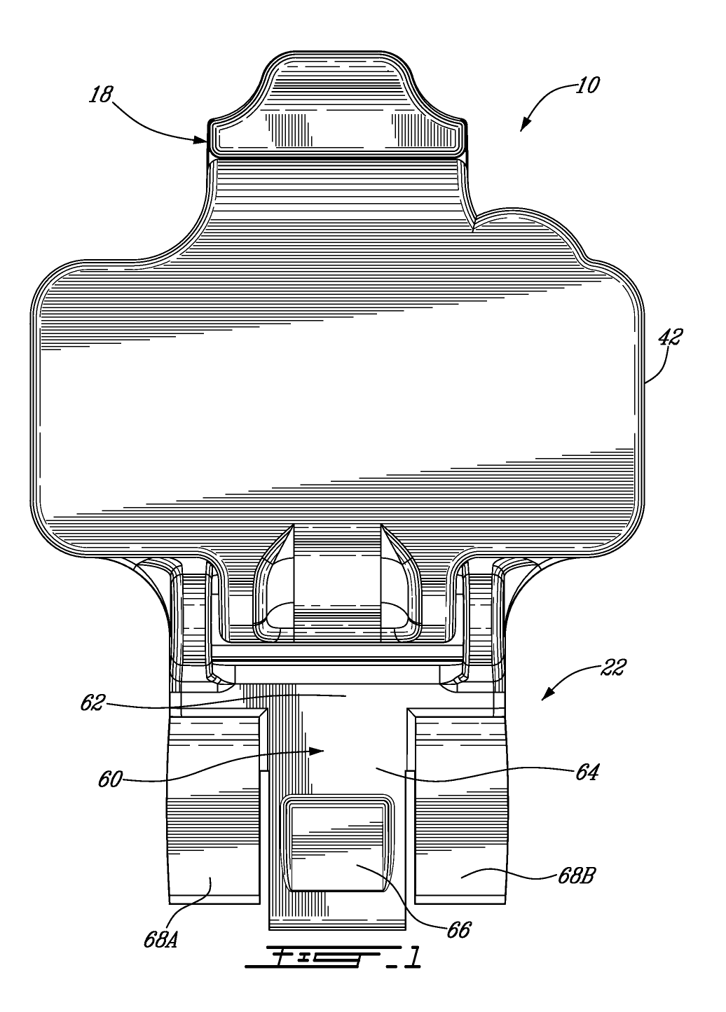

FIGS. 1, 2 and 3 show a clip 10 configured to the mounted on headwear, helmet or a hard hat for clipping a variety of articles thereto.

The clip 10 includes a first body member 12 having a main body portion 14 defining a rear side 16 for being mounted to a hardhat or helmet. The main body portion 14 has a generally rectangular-like configuration and is contiguous with an outwardly curved top portion 18 flaring away from the rear side 16 and with a bottom extending portion 20.

A second body member in the form of a door member 22 is moveably mounted to the first body member 12 at the front face 24 thereof.

The door member 22 includes a C-shape configuration having a main body portion 26, as well as top and bottom inwardly protruding portion 28 and 30 respectively. The bottom portion 30 is pivotally connected to a connector portion 32 15 forwardly protruding from the front face 24 of the first body member 12. The top portion 28 includes an upwardly protruding tongue 34 that is snap fitted within a complementary notch 36 formed in the inner face 38 of the first body top portion 18.

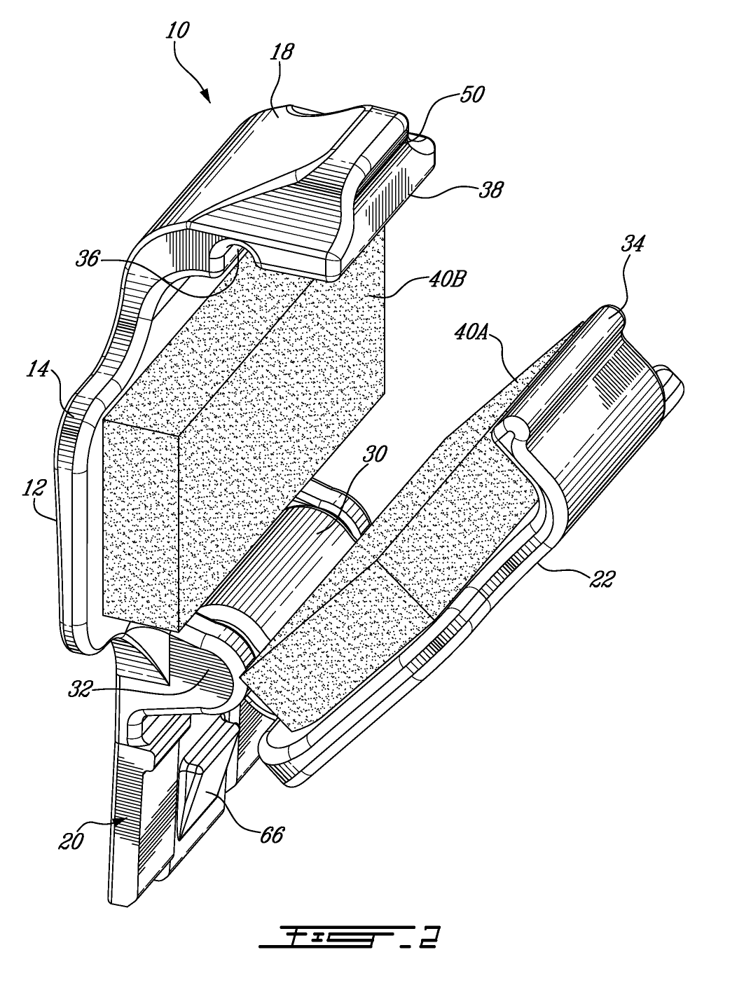

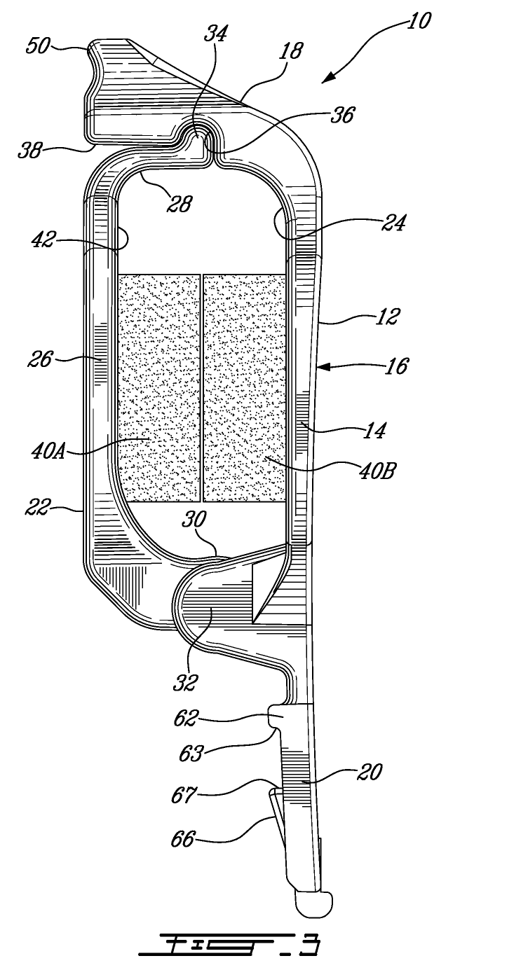

Therefore, the present clip 10 provides for opening the door member 22 as shown in FIG. 2 and closing the door member 22 as shown in FIG. 3. As such 20 the door member 22 is movable between open and closed positions relative to the first body member 12.

The clip 10 includes a pair of corresponding and opposite engaging elements 40A and 40B. Element 40A is mounted to the inner face 42 of the door member 22 and element 40B is mounted to the inner face 24 of the main body portion 14 of the first body member 12. The engaging elements 40A and 40B are deformable cushion elements which can easily engage therebetween a variety of articles having various sizes and configurations. These articles include without limitation pencils, pens, glasses goggles and the like which can be snugly sandwiched and held between the engaging elements 40A and 40B when the door member 26 is in the closed position.

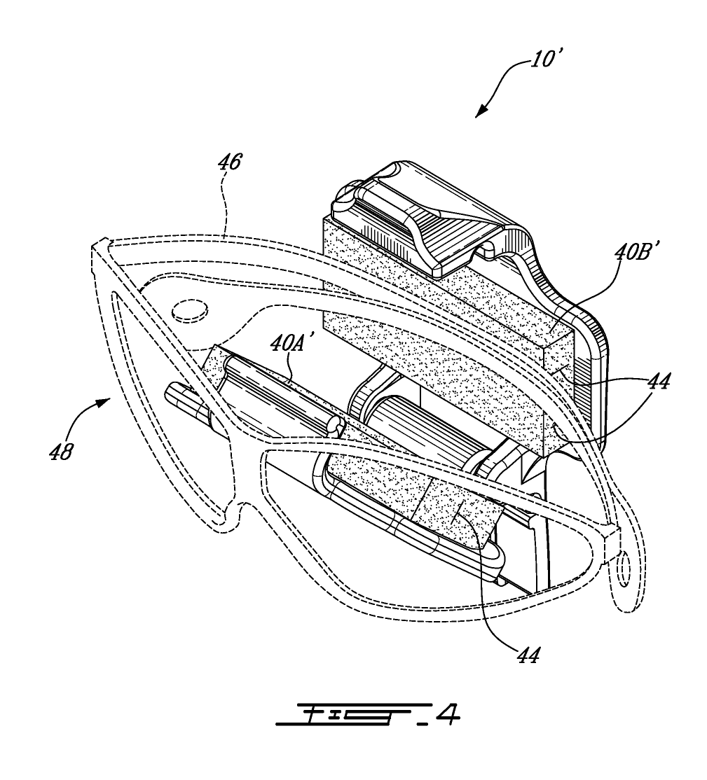

FIG. 4, shows a clip 10′ in accordance with an alternative embodiment. In this example, either one of the engaging elements 40A′ and 40B′ can include openings such as slits 44 in order to have articles such as the arms 46 of safety glasses 48 positioned therethrough.

The top portion 18 of the first body member 14 includes a tab 50 which allows the user for pushing the flexible portion 18 upwardly thereby releasing the tongue member 34 from the notch 36 and consequently allowing the door member 22 to pivotally fall to the open position.

As shown in FIG. 2, it is convenient that the pivotal connection between the door member 22 and the first body member 14 allows only a small opening 20 therebetween thereby avoiding a situation where articles are inadvertently dropped. In essence, when the clip 10 is in the open position, the article will still be positioned therein resting on portions 30 and 32.

The rear side 16 of the first body member 12 can be mounted to headwear by a variety of adhesive materials. Of course the clip 10 can also be fastened to headwear. The clip 10 can also be contiguous with the headwear.

With reference to FIG. 1, the bottom extension 22 includes a main T-shaped section 60 including a generally horizontal top portion 62 that defines a shoulder 63 and main vertical body portion 64 depending therefrom. The portion 64 is flexible relative to the main body 14 and includes a resilient and deformable protuberating portion 66 in the form of an upwardly sloped depressible member (shown better in FIGS. 2 and 3) defining a shoulder 67. A pair of downwardly extending side flaps 68A and 68B flank the main body portion 64 separately therefrom and slightly shorter in length. The flaps 68A and 68B also depend from the horizontal top portion 62 and are flexible relative to the main body 14.

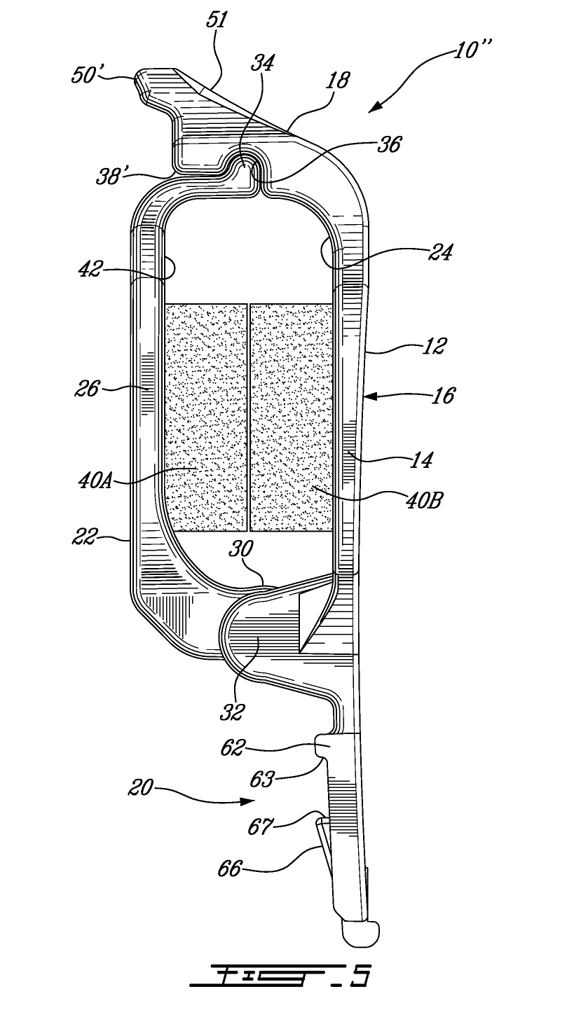

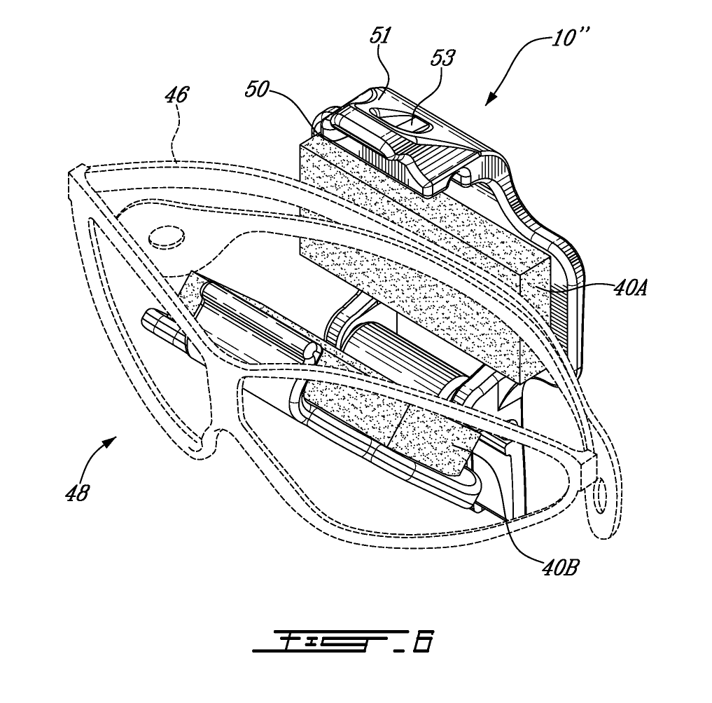

FIGS. 5 and 6 show a clip 10″ in accordance with another embodiment. Clip 10″ is similar to clips 10 and 10′ with the difference being that the inner face 38′ is shorter in length that inner face 38 providing for a more pronounced tab 50 with a rear side 51 having an opening 53. Unlike clip 10′, the cushions 40A and 40B of clip 10″ do not include slits.

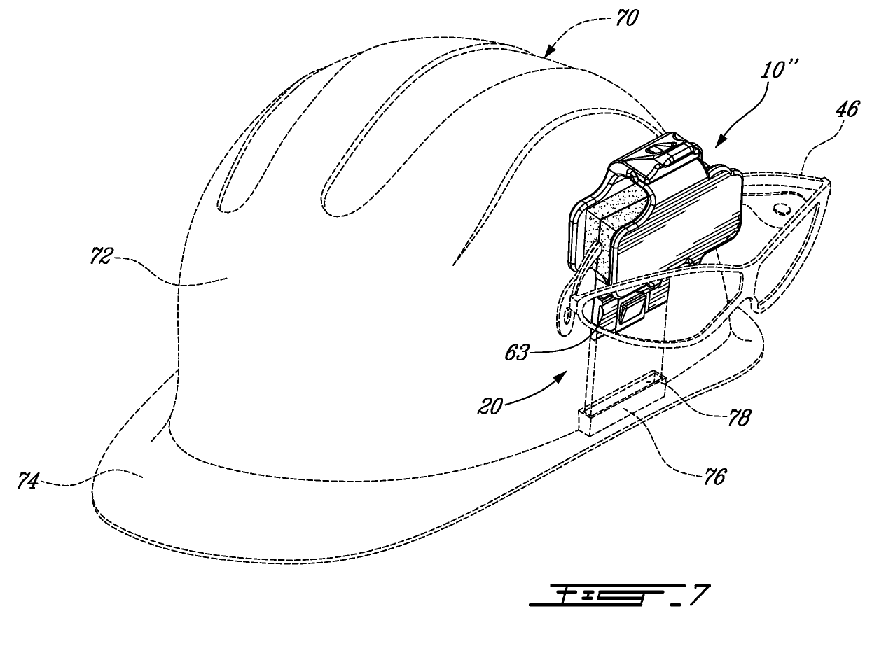

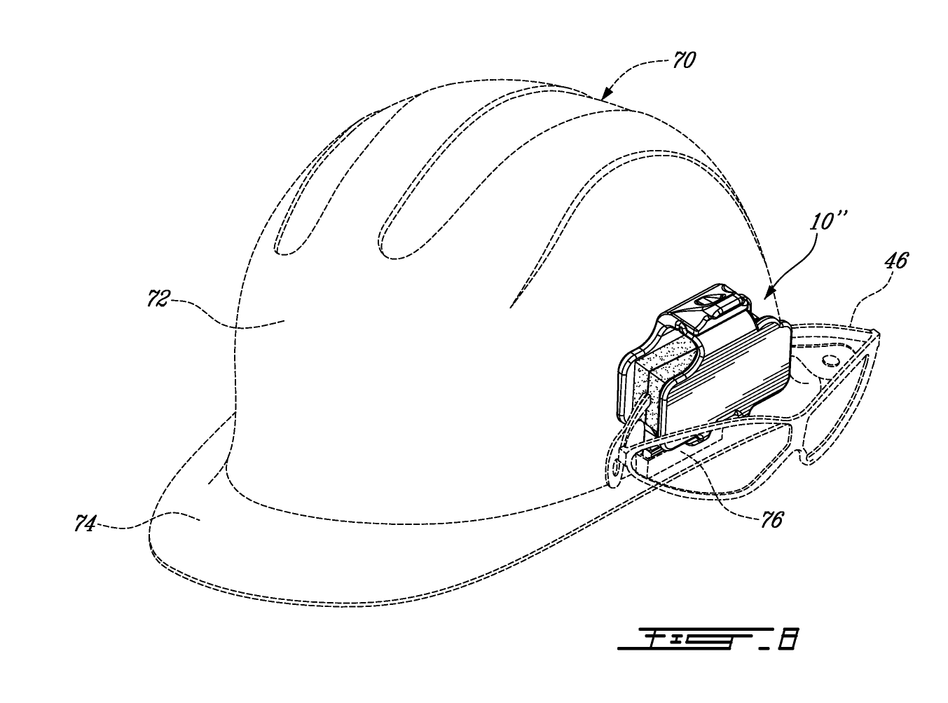

FIGS. 7 and 8 show a hard hat 70 comprising a shell 72, a rim 74 and an elongated slot structure 76 defining a slot 78.

The clip 10″ is mounted to the hard hat 70 by inserting its portion 20 into the slot 78. The foregoing is achieved by squeezing the depressible element 66 therethrough until it passes through underside of the rim 74, at which point the shoulder 63 engages the structure 76 and rests thereon with the shoulder 67 engaging the underside of the rim 74 directly adjacent the slot 78. Therefore, the hard hat 70 is grasped between the shoulders 63 and 67, with the first and second body members 14 and 22 upstanding from portion 62 that sits on the structure 76.

The flaps 68A and 68B provide a secure fit with the structure 76.

The foregoing provides for locking the clip 10″ onto the hard hat 70.

When removing the clip 10″ from the hard hat 70, the user will depress the element 66 flat down and pull the clip 10″ upwards out of the slot 78.

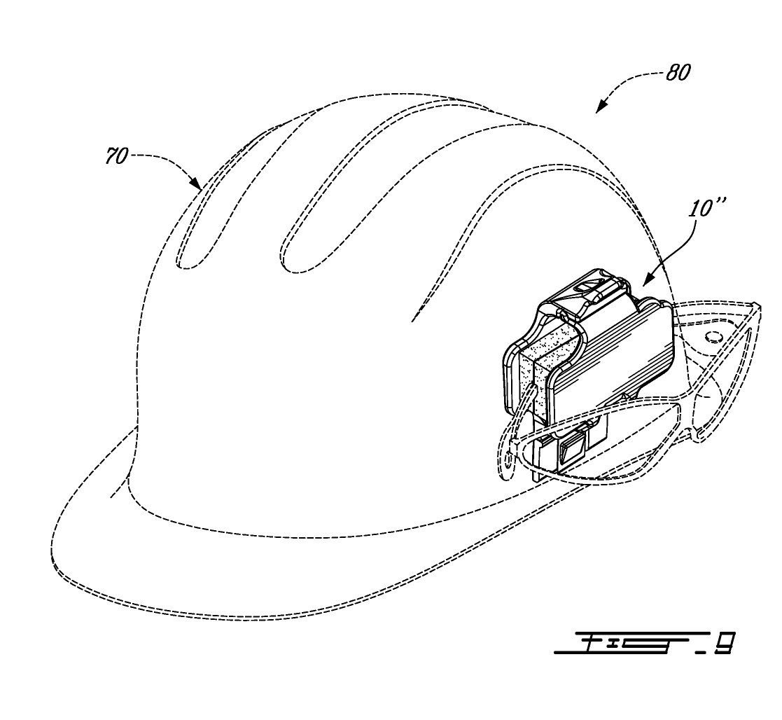

In another embodiment shown in FIG. 9, a headwear such as a hard hat 70 comprising a clip 10″ mounted thereto via an adhesive is provided thereby forming an assembly 80

The various features described above can be combined in a variety of ways to provide other non-illustrated embodiments within the scope of the present description. Although the present description hereinabove has been provided by way of non-restrictive illustrative embodiments thereof, it can be modified, without departing from the scope, spirit and nature of the appended claims.

What is claimed is:

1. A clip for holding articles and being mountable to headwear, the clip comprising:
a first body member having a portion thereof including a first mating element; and
a second body member pivotally mounted to the first body member at one end thereof and having a second end thereof including a second mating element, the second body member being movable between a closed position wherein the first and second elements are mutually engaged and an open position wherein the first and second elements are disengaged thereby providing for the second body member to pivot away from the first body member;
wherein when in the closed position the first and second body members provide for holding articles therebetween.

2. A clip according to claim 1, wherein the first mating element comprises a notch and the second mating element comprises a corresponding tongue.

3. A clip according to claim 1, wherein the first and second body members comprise inner sides comprising respective deformable elements for holding the articles therebetween.

4. A clip according to claim 4, wherein the respective deformable elements comprise respective slits.

5. A clip according to claim 1, wherein the clip defines top and bottom ends, the mating elements being positioned at the top end of the clip thereof.

6. A clip according to claim 1, further comprising a bottom extension comprising a depressible and resilient protuberating portion.

7. A clip according to claim 6, wherein the protuberating portion is upwardly sloped defining a shoulder.

8. A clip according to claim 7, wherein the bottom extension comprises an additional shoulder positioned above the shoulder defined by the depressible member.

9. A clip according to claim 6, wherein the bottom extension comprises a main portion flanked by pair of separate flaps.

10. A clip according to claim 1, wherein the first mating element comprises a tab extending therefrom providing for manual disengagement of the first mating element from the second mating element when in the closed position.

11. A clip for holding articles and being mountable to headwear comprising a shell, a rim and a slot structure defining a slot that leads to the underside of the rim, the clip comprising:
a first body member having a portion thereof including a first mating element;
a second body member pivotally mounted to the first body member at one end thereof and having a second end thereof including a second mating element, the second body member being movable between a closed position wherein the first and second elements are mutually engaged thereby providing for the first and second body members to hold articles therebetween and an open position wherein the first and second elements are disengaged thereby providing for the second body member to pivot away from the first body member; and
a bottom extension for being fitted thought the slot thereby mounting the clip to the headwear, the bottom extension extending from the first body portion and comprising a protuberating deformable and resilient portion forming a shoulder and being depressible,
wherein when fitting the bottom extension into the slot, the protuberating portion is so depressible as to provide for the bottom extension to be positioned through the slot structure.

12. A clip according to claim 11, wherein when the bottom portion is fitted through the slot, the shoulder of the protuberating portion engages the rim underside thereby acting as a stopper against disengaging the clip from the headwear.

13. A clip according to claim 11, wherein the bottom portion further comprises an additional shoulder, wherein when the bottom portion is fitted through the slot, the additional shoulder engages the slot structure.

14. A clip according to claim 11, wherein the protuberating portion comprises an upwardly sloped depressible member.

15. A clip according to claim 11, wherein the first mating element comprises a notch and the second mating element comprises a corresponding tongue.

16. A clip according to claim 11, wherein the first and second body members comprise inner sides comprising respective deformable elements for holding the articles therebetween.

17. A clip according to claim 16, wherein the respective deformable elements comprise respective slits.

18. A clip according to claim 11, wherein the clip defines top and bottom ends, the mating elements being positioned at the top end of the clip thereof.

19. A headwear and clip combination comprising:
a headwear comprising a shell, a rim and a slot structure defining a slot that leads to the underside of the rim; and
a clip mountable to the headwear for holding articles, the clip comprising:
a first body member having a portion thereof including a first mating element;
a second body member pivotally mounted to the first body member at one end thereof and having a second end thereof including a second mating element, the second body member being movable between a closed position wherein the first and second elements are mutually engaged thereby providing for the first and second body members to hold articles therebetween and an open position wherein the first and second elements are disengaged thereby providing for the second body member to pivot away from the first body member; and
a bottom extension for being fitted thought the slot thereby mounting the clip to the headwear, the bottom extension extending from the first body portion and comprising a protuberating deformable and resilient portion forming a shoulder and being depressible,
wherein when fitting the bottom extension into the slot, the protuberating portion is so depressible as to provide for the bottom extension to be positioned through the slot structure.
